(19) United States
(12) Patent Application Publication
(10) Pub. No.: US 2005/0005304 A1
(43) Pub. Date: Jan. 6, 2005

(54) Superframe planning technique for DVB-RCS networks

(76) Inventors: Ajai Kaul, Germantown, MD (US); Shekhar Vishwas Patankar, Nagpur (IN)

Correspondence Address: ALTIGY LLC, 9700 GREAT SENECA HIGHWAY, ROCKVILLE, MD, 20850, US

(21) Appl. No.: 10/840,388

(22) Filed: May 7, 2004

Related U.S. Application Data
(60) Provisional application No. 60/468,274, filed on May 7, 2003.

(51) Int. Cl. H04N 7/173; H04B 7/212; H04J 3/00

(52) U.S. Cl. 725/118; 725/117; 725/126; 370/337; 370/442

(57) ABSTRACT

This invention relates to a DVD-RCS superframe planning system comprising a method to specify input and an algorithm to generate optimal superframe layout. Specifically, this system allows automation of the superframe planning process. More specifically, this system generates an optimal layout that maximizes the user traffic while satisfying the requirements of operating at different symbol rates and a variety of slot types, coding types/rates and information lengths.

### CROSS-REFERENCE TO RELATED APPLICATIONS

This application claims priority to U.S. Provisional Application Ser. No. 60/468,274, Title “Superframe Planning technique for DVB-RCS Networks” filed on May 7, 2003 and incorporated herein by reference.

### FIELD OF THE INVENTION

This invention relates to technology for offering broadband services via satellite. Specifically, this invention relates to a method for automating the superframe planning process and generating an optimal layout within a DVB-RCS broadband network that maximizes user traffic.

### BACKGROUND OF THE INVENTION

Digital video broadcasting-return channel over satellite (DVB-RCS) has become a widely adopted multiple access control and signaling standard for broadband satellite communication. This standard specifies both a DVB-S-based shared forward channel for transmitting traffic and signaling to the user terminal, and a multi-frequency time division multiple access (TDMA) based return channel to transmit traffic and signaling from the user terminal. The DVB-RCS standard can be used on conventional “bent-pipe” satellites as well as the newer “on-board processing” capable satellites.

The multi-frequency TDMA return channel as specified by the DVB-RCS standard provides significant flexibility. The key concepts used in describing the return channel are superframes, frames, and TDMA time slots. The return channel is composed of one or more superframes. A superframe denotes a portion of the return channel resources—frequency and time. Each superframe has a fixed periodicity and repeats itself indefinitely in time. A superframe consists of frames, which in turn consist of TDMA time slots. A TDMA time slot is the basic unit of transmission for a user terminal and is used to carry user traffic and/or signaling. The parameters of a TDMA time slot are its symbol rate, slot type (CSC, ACQ, SYNC, TRF-ATM-1, etc.), coding type (Turbo/Convolutional), coding rate, information length (number of ATM cells or MPEG packets), CRC, etc. Together with these TDMA parameters, time and frequency offsets and the superframe counter are used to uniquely identify a given time slot.

The current DVB-RCS standard allows a superframe to contain frames that contain time slots of different types, symbol rates, and different TDMA parameters. For example, a single superframe may have one ATM cell TRF time slots that operate at 256 KSymbols/sec and 1024 KSymbols/second, with Turbo rate ½ and rate ⅔ coding, etc.

A given user terminal is assigned to a particular superframe when it logs on to the network and uses timeslots in that superframe for transmitting its data and signaling information. Thus, a given terminal is restricted to transmitting on time slots only in that superframe. Hence, it is desirable that time slots of different types and different TDMA parameters belong to a single superframe. This helps: (1) address rain fade conditions without reassigning a user terminal to a different superframe; (2) carry user traffic with different Quality of Service (QoS) requirements on time slots with different coding and symbol rates; and (3) transmit user traffic more efficiently—for example, when a terminal is sending only short data or acknowledgment traffic it may be assigned “one ATM cell” type of time slots, whereas when it is uploading data it may be assigned “four ATM cell” type of time slots.

Typically, a DVB-RCS Hub will have an entity called a “Slot Scheduler” that uses the superframe layout and assigns slots to various terminals. For the Slot Scheduler to work effectively, a superframe layout must lead to minimal blocking of slots (due to overlap).

It is a challenge to describe the composition of a superframe and generate a layout that satisfies the following requirements:
1. Allows multiple slot types with different TDMA parameters
2. Maximizes the traffic rate by reducing any wasted capacity in the frame
3. Lays out slots such that Slot Scheduler will face minimal blocking

Currently, most DVB-RCS systems use simple superframe layouts and the layouts are generated manually. Given a large network with multiple carriers operating at different symbol rates and a variety of slot types, coding types/rates and information lengths, generating a superframe layout manually may be inefficient (i.e. wasteful of capacity), if not impossible. Also, the manual techniques typically generate a layout for fixed superframe duration (e.g. 26.5 ms) and do not offer the flexibility of searching for efficient layouts that are close to a desired superframe duration but better in terms of traffic throughput.

There remains a need for a technique that not only allows automation of the superframe planning process, but also generates an optimal layout that maximizes user traffic while satisfying the requirements outlined above.

### BRIEF SUMMARY OF THE INVENTION

An object of the present invention provides a method for performing superframe planning for a network based on the DVB-RCS standard and in general any MF-TDMA based satellite/wireless/cable networks. In one embodiment, the method is amenable to implementation in an automated tool useful for a network designer designing the superframe structure for a DVB-RCS network. This method maximizes the traffic throughput for the superframe while satisfying the constraint of superframe length and desired slots per second for each slot type to be used in the superframe.

An aspect of the present invention provides a unique method for specifying the inputs for planning a DVB-RCS superframe. Another aspect of the present invention provides an algorithm to generate the optimal superframe layout.

This method of performing superframe planning allows a designer of a DVB-RCS network to include slots of multiple slot types, symbol rates, coding types, coding rates and information lengths in a single superframe.

### BRIEF DESCRIPTION OF THE DRAWINGS

FIG. 1 depicts an embodiment of the present invention relating to a sample output of the proposed method. In this example, the superframe consists of one carrier group. The carrier group consists of CSC, ACQ, SYNC, TRF ATM-1 and TRF ATM-4 slots. CSC, ACQ and SYNC slots are laid in columns; TRF slots are given “full carriers”. The figure also shows one “fractional carrier” with both TRF-1 and TRF-4 slots.

FIG. 2 depicts a sample merging of CSC and ACQ columns. Two CSC and two ACQ columns are merged into one CSC, one ACQ and one column containing both CSC and ACQ slots.

FIG. 3 depicts a sample layout of CSC, ACQ and SYNC slots in rows. This type of arrangement may be desirable if the carrier group has a large number of carriers.

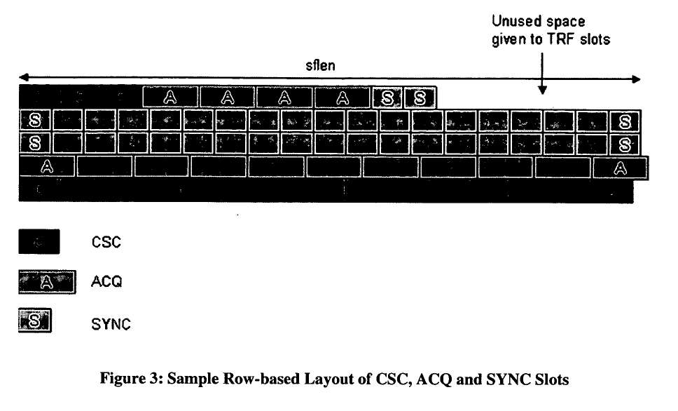

### DETAILED DESCRIPTION OF THE INVENTION

It is to be understood that this invention is not limited to the particular methodologies, protocols, constructs, algorithms, or components described and as such may vary. It is also to be understood that the terminology used herein is for the purpose of describing particular embodiments only, and is not intended to limit the scope of the present invention.

It must also be noted that as used herein and in the appended claims, the singular forms “a,” “an,” and “the” include plural references unless the context clearly dictates otherwise.

Unless defined otherwise, all technical and scientific terms used herein have the same meaning as commonly understood to one of ordinary skill in the art to which this invention belongs. Although any methods, devices, and materials similar or equivalent to those described herein may be used in the practice or testing of the invention, the preferred methods, devices, and materials are herein described.

All publications and patents mentioned herein are incorporated herein by reference for the purpose of describing and disclosing, for example, the constructs and methodologies described in the publications that might be used in connection with the presently described invention. The publications discussed above and throughout the text are provided solely for their disclosure prior to the filing date of the present application. Nothing herein is to be construed as an admission that the inventor may not be entitled to antedate such disclosure by virtue of prior invention.

Definitions:

CarrierGroup—as used herein, this refers to a group of carriers within a superframe operating at the same symbol rate.

desired_sps[0, . . . , num_SlotDef-1]—as used herein, refers to an array containing the desired number of slots per second. The array holds the values in the order of CSC, ACQ, SYNC (if any), followed by TRF slots.

minRetuneTime—in this context, refers to the minimum time to retune the tuner to be able to transmit a slot on a different frequency. Some RCSTs in a DVB-RCS network have a single tuner for transmitting TDMA slots. The minRetuneTime is measured in PCR count intervals.

MPEG packets—in this context, refers to a packet of 188 octets in length, as defined by the Motion Pictures Expert Group that may be used to transport user data.

nonTRF—as used herein, these SlotDefs do not carry user traffic, but signaling (control and management) information from the RCST. Examples of nonTRF SlotDefs are CSC, ACQ or SYNC SlotDefs.

nontrf_sflen—as used herein, refers to the length of the superframe occupied by nonTRF slots, used in case of a columnar arrangement of nonTRF SlotDefs. This parameter is zero if nonTRF SlotDefs are arranged in a row manner.

num_carr—as used herein, refers to the number of carriers in the CarrierGroup.

num_cols[0, . . . , num_nonTRF]—as used herein, refers to a number of columns of a nonTRF slot type, used only for columnar arrangement of nonTRF SlotDefs.

num_full_carr[0, . . . , num_SlotDef-1]—as used herein, refers to a number of full carriers for a TRF type. The array has the same order as desired_sps and pcrlen arrays. Array entries 0, . . . , num_nonTRF-1 are not used if nonTRF SlotDefs are arranged in columns.

num_nonTRF—as used herein, refers to the number of nonTRF SlotDefs in the CarrierGroup.

num_TRF—as used herein, refers to the number of TRF SlotDefs in the CarrierGroup.

num_SlotDef—as used herein, refers to the number of SlotDefs in the CarrierGroup. It is equal to num_nonTRF+num_TRF.

num_slots_fractional_carr[0, . . . , num_nonTRF-1]—as used herein, refers to a number of slots that go on a frational carrier. Entries 0, . . . , num_nonTRF-1 are not used if nonTRF SlotDefs are arranged in columns.

PCR count interval—as used herein, PCR count intervals are used a measurement of time and is equal to one tick of a 27 MHz Program Clock Reference clock.

pcrlen[0, . . . , num_SlotDef-1]—as used herein, refers to an array containing the length of each SlotDef in PCR count intervals. The first step in the algorithm in this invention calculates the values in this array. The array has the same order of indexing as desired_sps array.

sflen—as used herein, this refers to the length of the superframe at the current step (in PCR count intervals).

SlotDef—as used herein, a SlotDef has complete information related to a slot and can be used to calculate its duration in PCR count intervals and to build its entry in the TCT SI table. SlotDef, in this context, refers to a slot within a CarrierGroup and its definition in terms of its symbol rate, slot type (CSC, ACQ, SYNC, TRF), coding type and coding rate, CRC field (present/absent), SAC fields (if any), information length (only in case of TRF slots: the number of ATM cells or MPEG packets) and guard time.

TRF—as used herein, refers to ATM or MPEG SlotDefs that are used to carry user traffic.

TRF-ATM-1—as used herein, refers to a TRF slot designed to transport one ATM cell.

TRF-ATM-2—as used herein, refers to a TRF slot designed to transport two ATM cells.

TRF-ATM-4—as used herein, refers to a TRF slot designed to transport four ATM cells.

TRF-MPEG—as used herein, refers to a TRF slot designed to transport one or more MPEG packets.

trf_sflen—as used herein, refers to the length of superframe occupied by TRF slots and is equal to sflen minus nontrf_sflen.

The DVB-RCS specifications (ETSI EN 301 790) allow a flexible superframe layout. This method allows a network designer to include slots of multiple slot types, symbol rates, coding rates, information lengths and other parameters in a single superframe. An embodiment of this invention makes it possible to support a superframe structure with slots of various types (CSC, ACQ, SYNC, TRF-ATM-1, TRF-MPEG, TRF-ATM-2, etc.), symbol rates, information length, coding rates, etc.

An embodiment of the present invention provides for the DVB-RCS superframe planning algorithm comprising at least one of the following inputs:

a description of the superframe in terms of CarrierGroups;

the maximum superframe bound;

a superframe window specified by minimum and maximum window duration of the window and the increment step to be used between these minimum and maximum values. An aspect of the present invention is the capability of the algorithm to search for optimal superframe layouts in the window and the multiples of the window, within the maximum superframe bound. For example, if the maximum superframe duration is 100 ms and the window is (26 ms, 26.6 ms), the algorithm will search for optimal superframe layouts in the windows (26 ms, 26.6 ms), (52 ms, 53.2 ms), (78 ms, 79.8 ms). An example of an increment step could be 0.1 ms;

the number of carriers operating at a particular symbol rate, in which the set of carriers that operate at a particular symbol rate is called a CarrierGroup;

description of each SlotDef in a CarrierGroup and desired number of slots per second for each SlotDef, within a particular CarrierGroup. This embodiment treats the input desired slots per second for nonTRF (CSC, ACQ and SYNC) SlotDefs as “hard” lower bounds. As such, the algorithm will stop if the desired slots per second for nonTRF SlotDefs are not achievable. The desired slots per second for TRF SlotDefs are treated such that the ratio of slots between different TRF slot types is (approximately) maintained;

minimum time it takes for terminals to retune to a different frequency—minRetuneTime; and

a parameter to force a columnar arrangement for nonTRF (CSC, ACQ and SYNC) slot types.

A further aspect of the present invention provides for the superframe planning algorithm comprising: (1) the optimal superframe length; and (2) the layout of the optimal superframe. In this embodiment of the invention, the algorithm performs an exhaustive search for an optimal superframe layout by generating the optimal superframe layout for each superframe length in the specified superframe window and its multiples at each increment step size. The figure of merit used to determine the optimality of a layout may include the traffic data rate achieved by that layout while satisfying the desired slots per second for each nonTRF SlotDef specified in the input. The layout that achieves the maximum traffic data rate is chosen as the optimal one. If two layouts achieve the same traffic data, then the layout that wastes less capacity is chosen. The wasted capacity of a layout denotes the portion of the superframe that is not occupied by any (TRF or nonTRF) slot. The wasted capacity of the layout is equal to the sum of durations not occupied by any slot on a carrier, multiplied by the symbol rate of the carrier across all the carriers, divided by the superframe duration. When two superframe layouts achieve the same data rate, the layout that has less wasted capacity will have more nonTRF slots achieved per second. If two superframe layouts have the same traffic data rate and wasted capacity, the shorter superframe layout is chosen.

It is also possible for our algorithm to use alternate figure of merit criteria. For example, in one embodiment of our method, one may choose a layout that achieves the highest percentage of 1-ATM-cell time slots if the achieved traffic data rate of that layout is within a certain threshold of the maximum traffic data rate achieved by any layout.

Moreover, at each step (i.e., for each superframe length value in the superframe window and its multiples) the optimal superframe layout may be obtained by generating an optimal layout for each CarrierGroup specified in the input. The traffic data rate achieved by the entire superframe is equal to the sum of the traffic data rates of each CarrierGroup contained.

One example of an embodiment of the present invention may focus on a single CarrierGroup. The steps of generating the optimal layout for a particular CarrierGroup may include:

calculating the length of each SlotDef that is defined in the CarrierGroup, in PCR count intervals;

laying out nonTRF (CSC, ACQ and SYNC) SlotDefs in row or columnar arrangement across the carriers. The embodiment of this invention tries both row and columnar alternatives and chooses the best. If the user has mandated the use of a columnar approach, the columnar approach is utilized;

laying out TRF slots in “full” and “fractional” carriers maintaining slot alignments across carriers. A “full” carrier is one that has TRF slots of a single SlotDef type. A fractional carrier has TRF slots of more than one SlotDef type;

filling unutilized space on any carrier by shortest TRF slots, if possible;

filling unutilized space on any carrier with shortest nonTRF slots, if possible; and subsequently

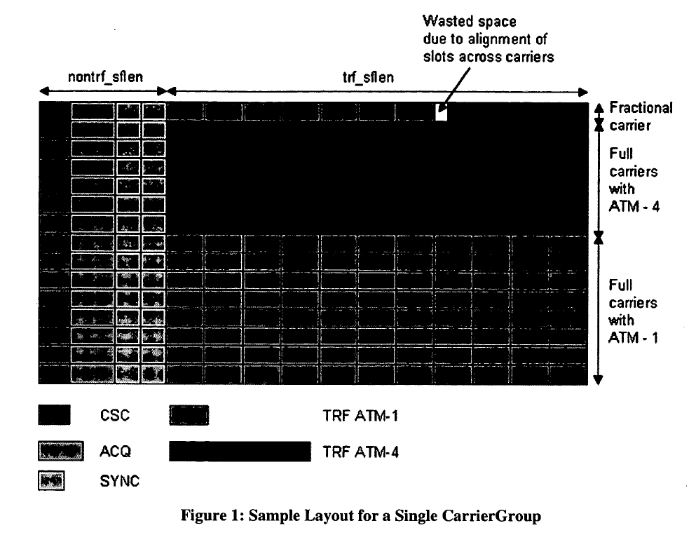

calculating the traffic data rate achieved and the wasted capacity of the layout. A sample layout for a single CarrierGroup is shown in FIG. 1.

One embodiment of the present invention relates to the arrangement of nonTRF SlotDefs. More specifically, the embodiment provides for both a row-based and a column-based approach for layout of nonTRF SlotDefs. In the row-based approach, the slots are laid out in rows occupying zero or more carriers completely and zero or more carriers partially. The column-based approach lays out the slots in vertical columns across all the carriers.

The advantages of laying out nonTRF slots in columnar arrangement in an embodiment of the present invention include the introduction of a “dead period” between TRF slots in successive superframes helping terminals with a single tuner that are not able to retune quickly. This dead period allows a Slot Scheduler, which works on a frame-by-frame basis, to ignore frequency hopping constraints across superframes. Additionally, a terminal that is trying to log on to the network is less likely to collide with a TRF slot assigned to another terminal because nonTRF slots are bunched together in a columnar arrangement. Collision may occur due to inaccurate initial frequency and/or timing estimate by the terminal.

Laying out nonTRF slots in a row arrangement may possibly increase the maximum data rate achieved by a single terminal (because a portion of the superframe may not have any TRF SlotDefs in the columnar arrangement of nonTRF SlotDefs). Moreover, a row arrangement may be preferable in the case of a large number of carriers and a relatively small superframe length because the row arrangement will increase traffic throughput.

The present invention may analyze both row and columnar arrangements and choose the arrangement that achieves the higher data rate. If the input specifies the use of a columnar arrangement, then only the columnar arrangement is generated.

In an aspect of the present invention, the method to lay out nonTRF slots in a row arrangement is similar to the one used for laying out TRF slots, the details of which can be determined by one of ordinary skill in the art, without undue experimentation, in light of the present specification. For the row-based layout, one may initially calculate the number of slots per superframe for the particular SlotDef and the number of carriers completely occupied by the particular SlotDef. The remaining slots are laid out on a “mixed” nonTRF carrier. Unoccupied space on the “mixed” nonTRF carrier is filled with TRF slots at the end of the algorithm.

Further, to lay out nonTRF slots in columnar arrangement, one may first calculate the number of columns for each SlotDef on nonTRF using, for example, the following pseudo code:

I := 0
WHILE (I IS LESS THAN num_nonTRF)
... num_cols[I] := ROUND_UP((desired_sps[I] * sflen /
27000000) / num_carr))
... Increment(I)
ENDWHILE

Further, one may obtain the nontrf_sflen as follows:

nontrf_sflen := 0
I := 0
WHILE (I IS LESS THAN num_nonTRF)
... nontrf_sflen := nonTRF_sflen + num_cols[I] * pcrlen[I]
... Increment(I)
ENDWHILE

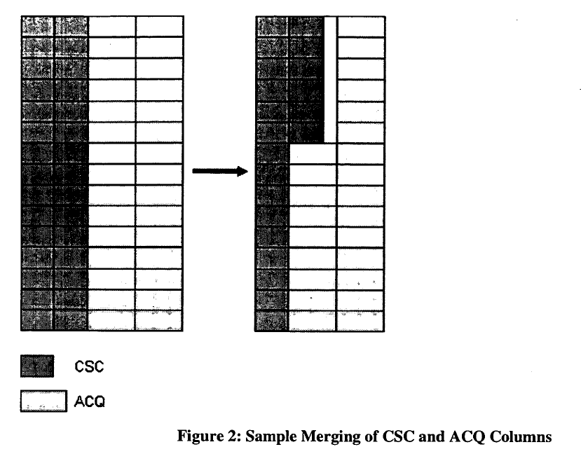

In an embodiment of the present invention, one may ascertain whether the nontrf_sflen can be reduced by merging columns of CSC, ACQ and SYNC slot types while satisfying the desired_sps for each slot type. Merging is possible because the number of columns is rounded up (as shown above). In some instances, the nontrf_sflen can be reduced by merging two or more different nonTRF slot types into a mixed column(s) while achieving the desired slots per second. FIG. 2 provides an example merging of CSC and ACQ columns. In this example, the sflen and desired_sps values are such that one may merge two CSC and two ACQ columns into one each of CSC and ACQ and a mixed column containing both CSC and ACQ slots.

In an embodiment of the present invention, if nontrf_sflen is greater than sflen following the previously described step in the method, then there is no superframe layout at the particular sflen and the algorithm continues to the next sflen value.

One embodiment of the present invention lays out the columns in the CSC, SYNC, ACQ (followed by TRF slots) order if the length of the superframe occupied by CSC columns and the length of the superframe occupied by the ACQ columns is greater than minRetuneTime. This embodiment provides the benefit of eliminating constraints of frequency-hopping between periodic SYNC slots with a TRF slot in the superframe. Alternatively, the columns may be laid out in the order of CSC, ACQ, SYNC (followed by TRF slots). This arrangement may limit the constraints of frequency hopping between SYNC slots and TRF slots to within the same superframe.

Another embodiment of the present invention relates to the arrangement of TRF slots. In an aspect of this embodiment, trf_sflen is calculated initially by simple subtracting nontrf_sflen from sflen. As previously discussed, the desired slots per second for TRF slots is not a “hard” lower bound and the present invention maximizes the traffic throughput thus maintaining the ratio between slots of different TRF SlotDefs. If a row-based approach was chosen for nonTRF slots, then the num_carr is reduced by the number of carriers with nonTRF slots.

In an embodiment of the present invention, the number of full carriers for each TRF SlotDef may be calculated to derive a layout of the TRF slots in the current CarrierGroup. In the present invention, the relative ratio of desired slots per second for each TRF SlotDef may be maintained by initially calculating the pcr_fraction for each TRF SlotDef. For example, the pcr_fraction is calculated to approximately maintain the ratio of desired slots per second for TRF SlotDefs as follows:

total_trf_pcr := 0
I := num_TRF
WHILE (I IS LESS THAN num_SlotDef)
... total_trf_pcr := total_trf_pcr + desired_sps[I] * pcrlen[I]
... Increment(I)
ENDWHILE
I := num_TRF
WHILE (I IS LESS THAN num_SlotDef)
... pcr_fraction[I] := (desired_sps[I] * pcrlen[I]) / total_trf_pcr
... Increment(I)
ENDWHILE

Further, the number of full carriers for each TRF SlotDef may be calculated as follows:

I := num_TRF
WHILE (I IS LESS THAN num_SlotDef)
... num_full_carr[I] := ROUND_DOWN(pcr_fraction[I] *
num_carr)
... Increment(I)
ENDWHILE

At this stage, the number of full carriers for each TRF slot type has been determined. The number of slots on a full carrier for TRF slot type “I” is ROUND_DOWN (trf_sflen/pcrlen[I]). Further, the SlotDefs of the same TRF slot type may be aligned in columns across carriers.

Another aspect of the present invention lays out the fractional carriers by calculating the number of TRF slots for each TRF SlotDef type that go on fractional carriers. When slots are laid out on fractional carriers, they are positioned such that they will be aligned to the TRF slots of the same kind on full carriers. Although this may lead to some wasted space, it ultimately reduces blocking for the Slot Scheduler and increases overall system utilization. For example:

I := num_TRF
WHILE (I IS LESS THAN num_SlotDef)
... num_slots_fractional_carr[I] := (pcr_fraction[I] *
(num_carr − num_full_carr[I]) * trf_sflen / pcrlen[I]
... Increment(I)
ENDWHILE

In another aspect of the present invention, the number of fractional carriers may be calculated and laid out. The number of fraction carriers can be at most numTRF-1. For example:

num_fractional_carriers := num_carr
I := num_TRF
WHILE (I IS LESS THAN num_SlotDef)
...... num_fractional_carriers := num_fractional_carriers −
num_full_carr[I]
...... Increment(I)
ENDWHILE
I := 0
WHILE (I IS LESS THAN num_fractional_carriers)
... temppcr := nontrf_sflen
... J := num_nonTRF
... WHILE (J IS LESS THAN num_SlotDef)
... ... WHILE ((temppcr IS LESS THAN sflen) AND (temppcr +
pcrlen[J]) IS LESS THAN sflen) AND
(num_slots_fractional_carr[J] IS GREATER THAN 0))
... ... ... /* Align the slot */
... ... ... align := (temppcr − nontrf_sflen) MODULO pcrlen[J]
... ... ... IF ((align IS EQUAL TO 0) OR ((align IS GREATER
THAN 0) AND
... ... ... (temppcr + pcrlen[J] − align + pcrlen[J]) IS LESS
THAN sflen))
... /* Assign one slot of TRF slot type that is indexed by j to
this fractional carrier */
... ... ... ... IF (ALIGN IS EQUAL TO 0)
... ... ... ... ... temppcr := temppcr + pcrlen[J]
... ... ... ... ELSE
... ... ... ... ... temppcr := temppcr + pcrlen[J] + pcrlen[J] −
align
... ... ... ... ENDIF
... DECREMENT num_slots_fractional_carrier[J]
... ... ... ELSE
... ... ... ... break
... ... ... ENDIF
... ... ENDWHILE
... ... Increment(J)
... ENDWHILE
... Increment(I)
ENDWHILE

In the present invention all the carriers may be subsequently searched for leftover space that may be filled using the smallest possible TRF SlotDefs. An object of the present invention may maintain the alignment of these TRF SlotDefs across various carriers.

An additional aspect of the present invention may search all the carriers anew for leftover space and may fill leftover space with the smallest possible nonTRF SlotDef. These nonTRF SlotDefs may not need to be aligned across carriers because multiple nonTRF slots are not allocated to the same terminal in the same frame.

Another aspect of the present invention provides that the traffic date rate achieved is the sum of the lengths of all TRF SlotDefs (in bits) across all carriers divided by the superframe length. In an embodiment of the present invention, the wasted capacity is the sum of all unutilized space across all carriers multiplied by the carrier's symbol rate divided by the superframe length.

1. A system for planning a DVB RCS superframe comprising:
specifying input with at least one of the following characteristics selected from the group consisting of maximum superframe duration,
superframe window for searching for an optimal superframe specified by minimum and maximum duration of the window measured in PCR count intervals,
increment step size to be used while searching for the optimal superframe measured in PCR count intervals, CarrierGroups that make up the superframe and symbol rate and number of carriers for each CarrierGroup
SlotDefs and the desired slots-per-second for each CarrierGroup,
minRetuneTime parameter, and Parameter to force columnar arrangement in nonTRF SlotDefs;
using an algorithm capable of optimizing superframe layout based on said inputs; wherein there is no restriction on the parameters of said SlotDefs, which include coding type, coding rate, information length, SAC fields, CRC, and guard time;
and wherein the same CarrierGroup may have SlotDefs of multiple types, coding types and rates and other parameters.

2. The system of claim 1, wherein the desired slots per second, is a hard lower bound for nonTRF SlotDefs.

3. The system of claim 1, wherein the desired slots per second is used to maintain relative ratio of number of slots achieved for TRF SlotDefs.

4. The system of claim 1, wherein the algorithm generates the optimal layout by performing an exhaustive search for superframe layouts at each superframe length in the superframe window and its multiples, within the maximum superframe duration, starting the superframe window search at the minimum duration and incrementing by the increment step size until the length exceeds the maximum duration.

5. The system of claim 1, wherein most traffic data rate achieved is used as the figure of merit to choose between superframe layouts, choosing the layout with less wasted capacity if two layouts have the same traffic data rate.

6. The system of claim 1, wherein the shorter layout is chosen when two layouts have the same traffic data rate and wasted capacity.

7. The system of claim 1, wherein alternate figure of merit can be used to choose the optimal superframe layout. Alternate figure of merit may include choosing a layout with highest percentage of 1-ATM-cell slots, when the traffic data rate achieved by the layout is within a certain threshold of the maximum traffic data rate of any layout.

8. The system of claim 1, wherein the traffic data rate of a superframe is equal to the sum of traffic data rates of its CarrierGroups.

9. The system of claim 1, wherein the wasted capacity of a superframe is equal to the sum of wasted capacities of its CarrierGroups.

10. The system of claim 1, wherein the nonTRF SlotDefs can be arranged in either columnar or row arrangement.

11. The system in claim 1, wherein the order of the columns is determined relative to the minRetuneTime parameter to reduce frequency-hopping conflicts between periodic SYNC and TRF SlotDefs in columnar arrangement of nonTRF SlotDefs.

12. The system of claim 1, wherein the remaining space on the mixed carrier of nonTRF SlotDefs is used for TRF SlotDefs in row arrangement of nonTRF SlotDefs.

13. The system of claim 1, wherein TRF SlotDefs are arranged in “full” and “fractional” carriers and wherein the alignment of similar TRF SlotDefs is maintained across carriers.

14. The system of claim 1, wherein the remaining space on carriers is filled with TRF SlotDefs of shortest duration maintaining alignment across carriers.

15. The system of claim 1, wherein the remaining space is filled with the shortest nonTRF SlotDef after filling leftover space with TRF SlotDef of the shortest duration.
